(19) United States
(12) Patent Application Publication
(10) Pub. No.: US 2026/0079069 A1
(43) Pub. Date: Mar. 19, 2026

(54) LEAK DETECTION APPARATUS

(71) Applicant: IDKLAB Inc., Daejeon (KR)

(72) Inventors: Won Tae HWANG, Daejeon (KR); Sung-Ho SHIN, Daejeon (KR); Hwan Soo KIM, Daejeon (KR); Song Hee LEE, Daejeon (KR); Yoo Joon LEE, Daejeon (KR); Ki Deok KIM, Daejeon (KR); Yong Seok LEE, Daejeon (KR); Jung Jin KIM, Daejeon (KR); Hyun Ju JUNG, Daejeon (KR)

(21) Appl. No.: 18/685,772

(22) PCT Filed: Aug. 19, 2022
(86) PCT No.: PCT/KR2022/012380

§ 371 Date: Apr. 30, 2025

(30) Foreign Application Priority Data
Aug. 23, 2021 (KR) 10-2021-0110771
Aug. 23, 2021 (KR) 10-2021-0110772
Oct. 7, 2021 (KR) 10-2021-0132892

(51) Int. Cl. G01M 3/22

(52) U.S. Cl. CPC G01M 3/22

(57) ABSTRACT

Disclosed is a leak detection apparatus. A leak detection apparatus according to one embodiment comprises: a clamp member which attaches to the connecting part of pipes; a color-change member which encircles at least a portion of the outer circumference of the clamp member, and the color of which changes due to leaked gas from the connecting part of the pipes; a first cover member covering the clamp member and comprising at least one recessed part for visually verifying the color-change member from the outside; and a second cover member comprising transparent material and covering the first cover member over the outer contours thereof.

### TECHNICAL FIELD

The following description relates to an apparatus that may observe and detect leak of gas or chemicals from a pipe connecting portion.

### RELATED ART

Pulsation and micro-vibration occurring inside a pipe may cause a joint that is a connecting portion of the pipe to become loose. Also, toxic gas or chemicals may corrode and harden an internal O-ring of a clamp and a sealing of a pipe joint. The event of an accident due to a leak of toxic gas or chemicals may cause massive property damage, loss of life, and loss of corporate reputation.

Also, the conventional clamp used in a pipe connecting portion has a difficulty in visually verifying a leak of hazardous materials and also removing the leaked hazardous materials.

### DETAILED DESCRIPTION

### Technical Subject

Example embodiments provide a leak detection apparatus that may visually verify a leak status of hazardous materials.

Example embodiments provide a leak detection apparatus that may verify a leak status of hazardous materials through an optical sensor.

Example embodiments provide a leak detection apparatus that prevents gas or chemicals from leaking to the outside such that a worker may safely remove hazardous materials.

Example embodiments provide a leak detection apparatus that may effectively remove hazardous materials when dealing with a leak accident.

### Solution

Provided is a leak detection apparatus including a clamp member configured to attach to a connecting portion of a pipe; a color-change member configured to surround at least a portion of outer circumference of the clamp member and of which color changes due to gas or chemicals leaking from the connecting portion of the pipe; a first cover member configured to cover the clamp member and including at least one groove for visually verifying the color-change member from the outside; and a second cover member configured to cover the first cover member and including a transparent material.

According to an aspect, the leak detection apparatus may further include an optical sensor configured to detect a change in the color of the color-change member through the at least one groove.

According to another aspect, the second cover member may further include a coupling member configured to couple the optical sensor at a position corresponding to the at least one groove included in the first cover member such that the optical sensor detects the change in the color of the color-change member.

According to still another aspect, the coupling member may include a transparent material such that the optical sensor detects the change in the color of the color-change member.

According to still another aspect, the leak detection apparatus may further include a drain configured to remove leaking gas or chemicals in a space between the clamp member and the first cover member.

According to still another aspect, the drain may be configured to connect the space between the clamp member and the first cover member and an external space of the leak detection apparatus through grooves formed in the first cover member and the second cover member.

According to still another aspect, the leak detection apparatus may further include a drain cover configured to insert into the second cover member through a groove formed in the second cover member while surrounding one side of the drain to prevent a leak of gas or chemicals through the drain.

According to still another aspect, the leak detection apparatus may further include at least one gas detection sensor provided through the groove formed in the first cover member and configured to detect gas or chemicals leaking from the connecting portion of the pipe into the first cover member.

According to still another aspect, the clamp member may include an upper clamp member configured to cover top of the pipe; and a lower clamp member configured to cover bottom of the pipe.

According to still another aspect, the first cover member may include an upper first cover member configured to surround the upper clamp member; and a lower first cover member configured to surround the lower clamp member.

According to still another aspect, the second cover member may include an upper second cover member configured to surround the upper first cover member; and a lower second cover member configured to surround the lower first cover member.

According to still another aspect, the leak detection apparatus may further include a fluorine rubber member configured to cover a gap between the upper second cover member and the lower second cover member and a gap between the second cover member and the pipe.

According to still another aspect, the leak detection apparatus may further include a locking device configured to couple the upper second cover member and the lower second cover member to prevent arbitrary separation between the upper second cover member and the lower second cover member.

According to still another aspect, the first cover member may contain austenitic stainless steel as a material.

According to still another aspect, the second cover member may contain polycarbonate or polyphenylene sulfide as a material.

According to still another aspect, the color-change member may include an upper color-change member configured to surround at least a portion of the upper outer peripheral surface of the clamp member along the upper outer peripheral curved surface of the clamp member; and a lower color-change member configured to surround at least a portion of the lower outer peripheral surface of the clamp member along the lower outer peripheral curved surface of the clamp member.

According to still another aspect, the leak detection apparatus may further include at least one gas detection sensor provided through the groove formed in the first cover member and configured to detect gas leaking from the connecting portion of the pipe into the first cover member.

### Effect

According to some example embodiments, it is possible to visually verify a leak status of hazardous materials through a color-change member of which color changes due to leaked gas or chemicals, a first cover member having a groove, and a second cover member including a transparent material.

According to some example embodiments, it is possible to verify a leak status of hazardous materials by detecting a change in color of a color-change member through an optical sensor.

According to some example embodiments, it is possible to prevent gas or chemicals from escaping a leak detection apparatus while providing enough time for a worker to remove hazardous materials.

According to some example embodiments, it is possible to effectively remove hazardous materials through a drain when dealing with a leak accident of the hazardous materials.

According to some example embodiments, it is possible to easily verify a leak status of hazardous materials and a leak position through a sensor.

According to some example embodiments, it is possible to prevent random manipulation on a leak detection apparatus through a locking device.

According to some example embodiments, it is possible to provide a leak detection apparatus with excellent durability through a first cover member made of austenitic stainless steel and a fluorine rubber member that covers a gap of the first cover member.

### BRIEF DESCRIPTION OF DRAWINGS

FIGS. 1 to 6 illustrate an example of a leak detection apparatus according to an example embodiment of the present invention.

FIG. 7 illustrates an example of a fluorine rubber member according to an example embodiment of the present invention.

FIG. 8 illustrates an example of an upper first cover member according to an example embodiment of the present invention.

FIG. 9 illustrates an example of a lower first cover member according to an example embodiment of the present invention.

FIG. 10 illustrates an example of a lower second cover member according to an example embodiment of the present invention.

FIG. 11 illustrates an example of a drain and a drain cover according to an example embodiment of the present invention.

FIG. 12 illustrates an example of a leak detection apparatus according to another example embodiment of the present invention.

FIGS. 13 and 14 illustrate an example of an optical sensor and a coupling member according to another example embodiment of the present invention.

FIG. 15 illustrates an example of a change in color of a color-change member according to another example embodiment of the present invention.

### BEST MODE

Hereinafter, example embodiments are described in detail with reference to the accompanying drawings. However, various modifications may be made to the example embodiments and the scope of the present application is not limited to or restricted by the example embodiments. It should be understood that the example embodiments include all changes, equivalents, and substitutions within the claims.

The terms used herein are used to simply explain specific example embodiments and are not construed to limit the present invention. The singular forms “a,” “an,” and “the,” are intended to include the plural forms as well, unless the context clearly indicates otherwise. It will be further understood that the terms “comprises/comprising (incudes/including),” and “has/having” when used in this specification, specify the presence of stated features, integers, steps, operations, elements, components, or groups thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which example embodiments belong. Terms, such as those defined in commonly used dictionaries, should be interpreted as having a meaning that is consistent with their meaning in the context of the relevant art, and should not be interpreted in an idealized or overly formal sense unless expressly so defined herein.

Also, when describing with reference to the accompanying drawings, like reference numerals refer to like elements throughout the present specification and repeated description related thereto is omitted. When it is determined that detailed description related to the related known art may make the example embodiments unnecessarily ambiguous, the detailed description is omitted.

Also, the terms “first,” “second,” “A,” “B,” “(a),” “ (b),” etc., may be used herein to describe various components of example embodiments. However, these terms are only used to distinguish one component from another component and essence or turn or order of a corresponding component is not construed by the term. For example, when a component is referred to as being “connected to,” “coupled to,” or “accessed to” another component, it should be understood that the component may be directly connected to or accessed to the other component, and still another component may be “connected,” “coupled,” or “accessed” between the components.

A component including a common function with a component included in one example embodiment is described using the same name in another example embodiment. Unless otherwise defined, description related to one example embodiment may also be applied to another example embodiment and detailed description within the overlapping range is omitted.

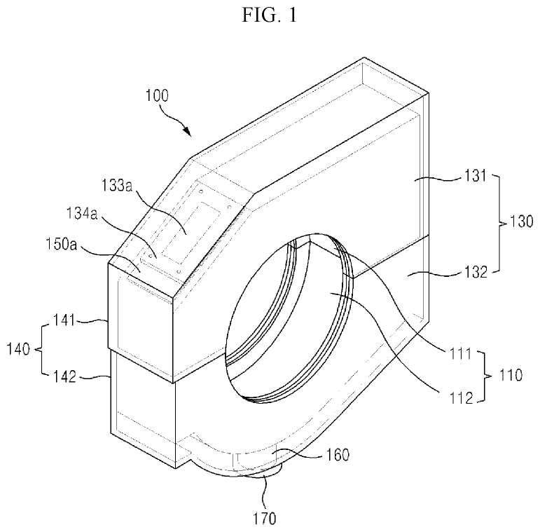

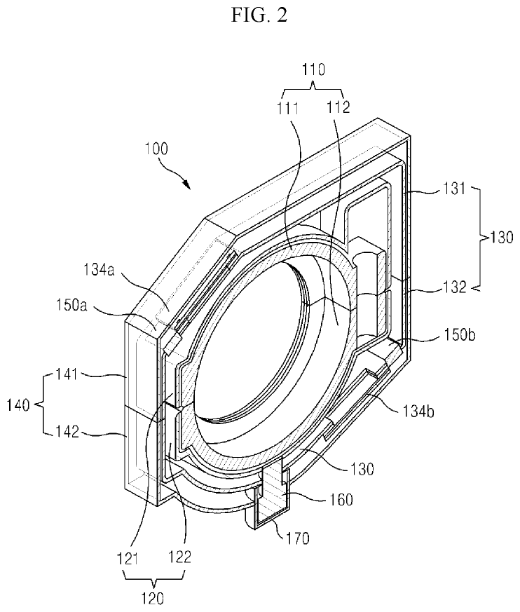

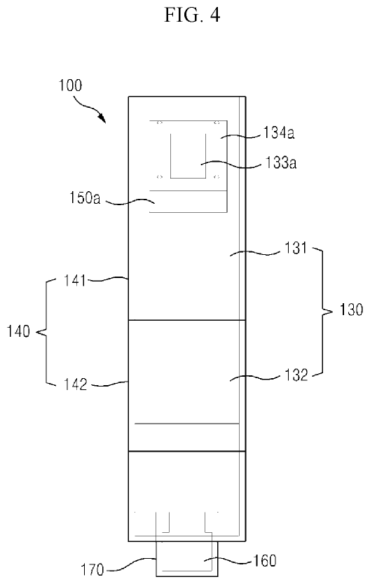

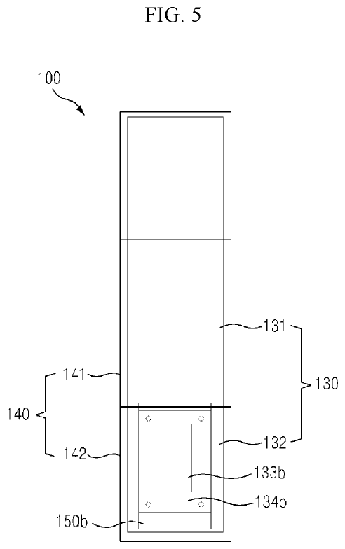

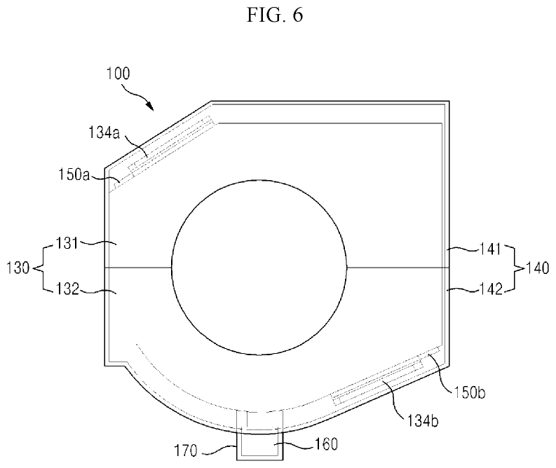

FIGS. 1 to 6 illustrate an example of a leak detection apparatus according to an example embodiment of the present invention. A leak detection apparatus 100 according to the example embodiment may include a clamp member 110, a color-change member 120, a first cover member 130, and a second cover member 140.

The clamp member 110 may be attached to a connecting portion of a pipe and may prevent the connecting portion from loosening or gas or chemicals from leaking. Here, the clamp member 110 may include an upper clamp member 111 configured to cover top of the pipe and a lower clamp member 112 configured to cover bottom of the pipe.

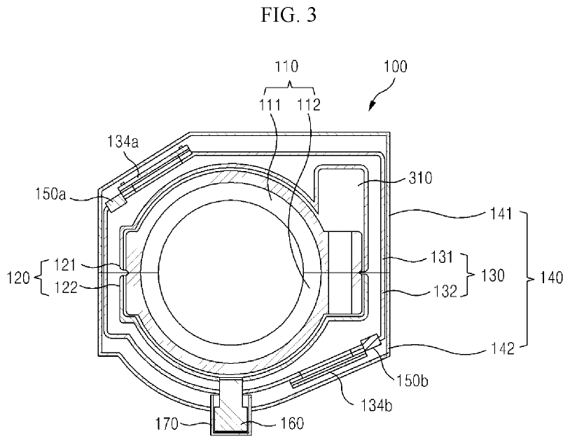

The color-change member 120 may be configured to surround at least a portion of the outer peripheral surface of the clamp member 110 and when gas leaks from the connecting portion of the pipe, color of the color-change member 120 may be configured to change due to leaked gas or chemicals. The example embodiment illustrates an example in which the color-change member 120 is configured to surround the entire outer peripheral surface of the clamp member 110. Here, as illustrated in FIG. 3, the color-change member 120 may form a space 310 for a screw portion to connect the upper clamp member 111 and the lower clamp member 112 to couple the clamp member 110 to the pipe. In the example embodiment, the color-change member 120 may include an upper color-change member 121 configured to surround at least a portion of the upper outer peripheral surface of the clamp member (at least a portion of the upper clamp member 111) along the upper outer peripheral curved surface of the clamp member 110 and a lower color-change member 122 configured to surround at least a portion of the lower outer peripheral surface of the clamp member 110 (at least a portion of the lower clamp member 112) along the lower outer peripheral curved surface of the clamp member 110.

The first cover member 130 may be configured to surround the clamp member 110. Here, the first cover member 130 may include an upper first cover member 121 configured to surround the upper clamp member 111 of the clamp member 110 and a lower first cover member 122 configured to surround the lower clamp member 112 of the clamp member 110. The color-change member 120 may be positioned between the clamp member 110 and the first cover member 130 and, as shown in FIG. 3, the first cover member 130 may be configured to surround the clamp member 110 while being spaced a certain distance from the clamp member 110 and the color-change member 120. Also, the first cover member 130 may be implemented to include one more grooves 133a and 133b. The grooves 133a and 133b may be used to visually verify the color-change member 120 placed inside the first cover member 130 from the outside. For example, the first groove 133a may be used to visually verify the upper color-change member 121 and the second groove 133b may be used to visually verify the lower color-change member 122. Also, to prevent a leak of gas or chemicals, windows 134a and 134b made of a transparent material, such as tempered glass, reinforced plastic, and the like, may be formed in the grooves 133a and 133b.

The second cover member 140 may be configured to surround the first cover member 130 and may be made of a transparent material. That is, the leak detection apparatus 100 may provide a structure that allows a user to visually verify a change in color induced by reaction between the color-change member 120 located in the first cover member 130 and gas or chemicals while preventing gas or chemicals leaking from the connecting portion of the pipe from escaping to the outside of the leak detection apparatus 100 through the grooves 133a and 133b and the windows 134a and 134b of the first cover member 130 and the second cover member 140 made of a transparent material. Depending on example embodiments, the second cover member 140 may be implemented such that only at least some portions, such as portions corresponding to the grooves 133a and 133b and the windows 134a and 134b, are transparent. The second cover member 140 may include an upper second cover member 141 configured to surround the upper first cover member 131 and a lower second cover member 142 configured to surround the lower first cover member 132. Also, depending on example embodiments, the leak detection apparatus 100 may further include a locking device (not shown) configured to couple the upper second cover member 141 and the lower second cover member 142 to prevent arbitrary separation between the upper second cover member 141 and the lower second cover member 142. The locking device may be used without limitation as long as the locking device is in a structure capable of coupling the upper second cover member 141 and lower second cover member 142 such that the upper second cover member 141 and the lower second cover member 142 are not arbitrarily separated.

Meanwhile, the leak detection apparatus 100 may further include one or more gas detection sensors 150a and 150b provided through the grooves formed in the first cover member 130 and configured to detect gas or chemicals leaking from the connecting portion of the pipe into the first cover member 130. Here, the gas detection sensors 150a and 150b may be implemented to output light and sound when gas or chemicals leaking from the connecting portion of the pipe is detected. In this case, as described above, since the second cover member 140 is made of a transparent material, users may visually verify the light output from the gas detection sensors 150a and 150b. Depending on example embodiments, when gas or chemicals leaking from the connecting portion of the pipe is detected, the gas detection sensor 150a and 150b may be implemented to transmit a warning signal to an external device through wireless communication, in addition to outputting light and sound. Here, the external device may be a server or a user terminal and the server may deliver the warning signal back to the user terminal to warn the user of a leak of gas or chemicals. In this case, identifiers of the gas detection sensors 150a and 150b may be transmitted with the warning signal such that the leak detection apparatus 100 leaking gas or chemicals may be identified and a position of the leak detection apparatus 100 leaking gas or chemicals may be quickly identified through such identifiers.

Also, the leak detection apparatus 100 may further include a drain 160 configured to remove leaking gas or chemicals in a space between the clamp member 110 and the first cover member 130. For example, the drain 160 may connect the space between the clamp member 110 and the first cover member 130 and an external space of the leak detection apparatus 100 through the grooves formed in the first cover member 130 and the second cover member 140. The leaked hazardous materials may be effectively removed through the drain 160. Also, the leak detection apparatus 100 may further include a drain cover 170 configured to insert into the second cover member 140 through a groove formed in the second cover member 140 while surrounding one side of the drain 160 to prevent a leak of gas or chemicals through the drain 160. Here, one side of the drain 160 may be a portion of the drain 160 that is exposed to the external space of the leak detection apparatus 100.

Meanwhile, the first cover member 130 may contain austenitic stainless steel as a material. In detail, for example, SUS304, which is used in a treatment tank due to its excellent chemical resistance and heat resistance, may be used as the material of the first cover member 130. However, austenitic stainless steel or SUS304 is provided as one example for the first cover member 130 and any material capable of providing high durability may be used without limitation.

Also, the second cover member 140 may contain polycarbonate as a material, but is not limited thereto. For example, any material having transparency and chemical resistance may be used as the material of the second cover member 140 without limitation.

Meanwhile, the color-change member 120 may use a color-change sensor that includes litmus paper or a color-change sensor that includes a nanofiber membrane coated with a color change dye, but is not limited thereto. Any color-change sensor that may function by being provided between the clamp member 110 and the first cover member 130 and of which color may change in response to detecting gas or chemicals leaking from the connecting portion of the pipe in which the leak detection apparatus 100 is installed may be used as the color-change member 120 without limitation.

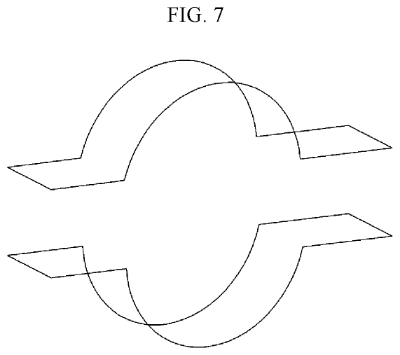

Also, the leak detection apparatus 100 may further include a fluorine rubber member configured to cover a gap between the upper second cover member 141 and the lower second cover member 142 and a gap between the second cover member 140 and the pipe. FIG. 7 illustrates an example of the fluorine rubber member according to an example embodiment of the present invention. Due to excellent durability of fluorine rubber as well as the first cover member 130 made of austenitic stainless steel, the leak detection apparatus 100 with excellent chemical resistance may be provided.

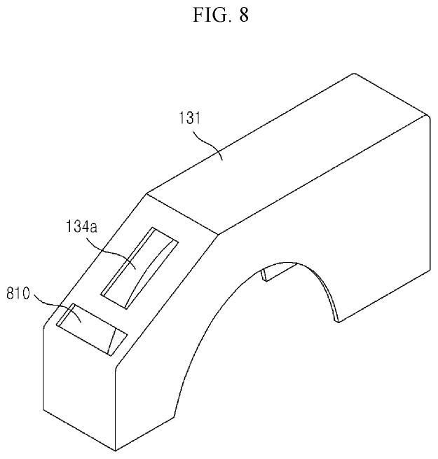

FIG. 8 illustrates an example of an upper first cover member according to an example embodiment of the present invention. As described above, the upper first cover member 131 according to the example embodiment allows visual observation of the internal upper color-change member 121 through the first groove 133a in which the first window 134a is to be installed. Also, the upper first cover member 131 may further include a groove 810 for installing the first gas detection sensor 150a capable of detecting gas or chemicals leaking into the first cover member 130 through the connecting portion of the pipe.

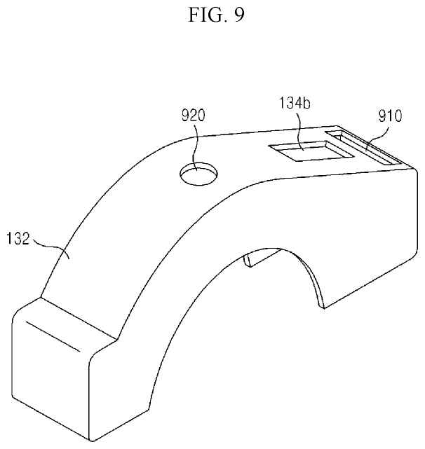

FIG. 9 illustrates an example of a lower first cover member according to an example embodiment of the present invention. As described above, the lower first cover member 132 according to the example embodiment allows visual observation of the internal upper color-change member 122 through the second groove 133b in which the second window 134b is to be installed. Also, the lower first cover member 132 may further include a groove 910 for installing the second gas detection sensor 150b capable of detecting gas or chemicals leaking into the first cover member 130 through the connecting portion of the pipe. Also, the lower first cover member 132 may further include a groove 920 for introducing one side of the drain 160 into the first cover member 130.

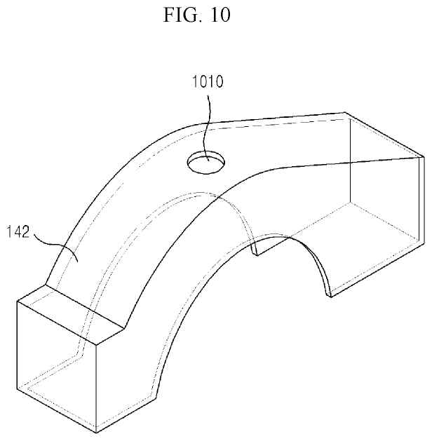

FIG. 10 illustrates an example of a lower second cover member according to an example embodiment of the present invention. The lower second cover member 142 according to the example embodiment may include a groove 1010 for introducing the drain 160 and the drain cover 170 into the interior. As described above, the lower second cover member 142 may include a material having transparency and chemical resistance.

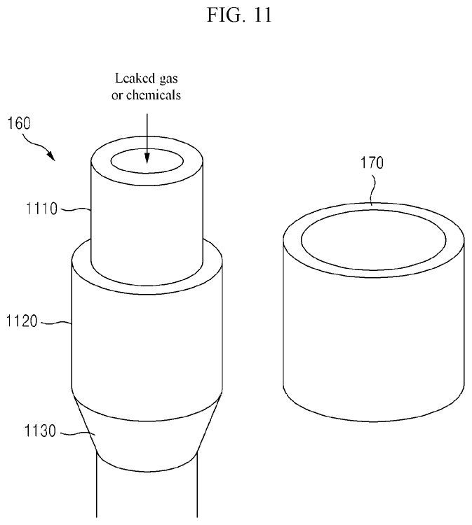

FIG. 11 illustrates an example of a drain and a drain cover according to an example embodiment of the present invention. An upper portion 1110 of the drain 160 may be coupled through the groove 920 of the lower first cover member 132 described with reference to FIG. 9 and may flow into the first cover member 130, and a lower portion 1120 of the drain 160 may flow into the second cover member 140 through the groove 1010 of the lower second cover member 142 described above with reference to FIG. 10. Here, the drain cover 170 for preventing gas or chemicals through the drain 160 may flow into the second cover member 140 with the drain 160 while surrounding the lower portion 1120 of the drain 160. If gas or chemicals leaks through the connecting portion of the pipe, the user of the leak detection apparatus 100 may remove the drain cover 170 from the drain 160 and then connect a valve 1130 to the drain 160, thereby efficiently removing gas or chemicals inside the first cover member 130.

As described above, according to example embodiments of the present invention, it is possible to visually verify a leak status of hazardous materials through a color-change member of which color changes due to leaked gas or chemicals, a first cover member having a groove, and a second cover member including a transparent material. Also, it is possible to effectively remove hazardous materials through a drain when dealing with a leak accident of the hazardous materials. Also, it is possible to easily verify a leak status of hazardous materials and a leak position through a sensor. Also, it is possible to prevent random manipulation on a leak detection apparatus through a locking device. Also, it is possible to provide a leak detection apparatus with excellent durability through a first cover member made of austenitic stainless steel and a fluorine rubber member that covers a gap of the first cover member.

The proposed technology may greatly contribute to effectively and precisely detecting a leak that occurs during a transportation and storage process of gas and chemicals essential in a semiconductor and display manufacturing process. In particular, since a color-change sensor (e.g., the color-change member 120) capable of visually identifying a leak of gas (e.g., Cl₂, BCl₃, BF₃, SF₆, CF₄, SiF₄SiH₃, etc.) and a leak of hazardous solvents including hydrofluoric acid, hydrochloric acid, sulfuric acid, etc., through a window portion (e.g., the windows 134a and 134b) is applied, a position of a pipe at which the leak occurs may be accurately found. In particular, by providing a complex system in which a color-change sensor capable of performing visual identification and a gas sensor capable of immediately recognize a reaction with gas and chemicals (an oxygen sensor that detects a change in oxygen concentration and a semiconductor gas sensor and an electrochemical gas sensor of which resistance changes through a chemical reaction or in which a change in a current/voltage value is induced) are simultaneously mounted, the accuracy of diagnosing a leak of gas and chemicals may be further improved. In addition, by including a drain portion (e.g., the drain 160 and the drain cover 170) capable of discharging hazardous factors, it is possible to secure a sufficient golden time for blocking the leak after a gas alarm or visual identification.

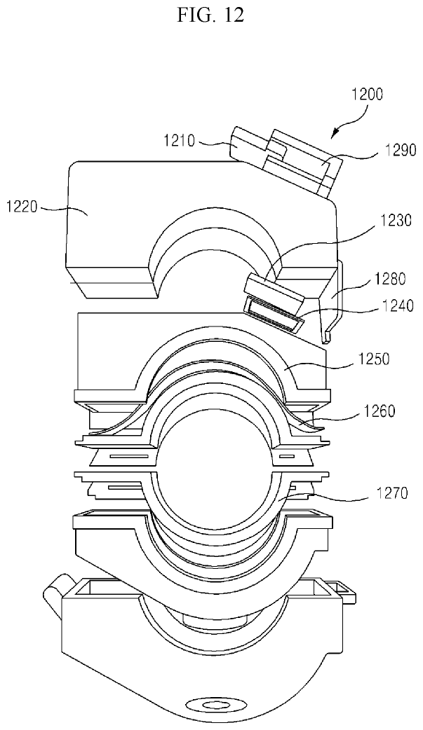

FIG. 12 illustrates an example of a leak detection apparatus according to another example embodiment of the present invention. A leak detection apparatus 1200 according to the example embodiment may include an optical sensor 1210, a second cover member 1220, a window 1230 made of a transparent material, a gasket 1240, a first cover member 1250, a color-change member 1260, a fluorine rubber member 1270, a locking device 1280, and a coupling member 1290.

Here, the first cover member 1250 may correspond to the aforementioned first cover member 130, the second cover member 1220 may correspond to the aforementioned second cover member 140, and the color-change member 1260 may correspond to the aforementioned color-change member 120. Also, the window 1230 may correspond to the aforementioned windows 134a and 134b, and the gasket 1240 may be provided between the first cover member 1250 and the window 1230 and used to prevent a leak of gas. The fluorine rubber member 1270 may correspond to the fluorine rubber member described with reference to FIG. 7. The locking device 1280 may couple an upper portion and a lower portion of the second cover member to prevent arbitrary separation between the upper portion and the lower portion of the second cover member 1220.

Meanwhile, the optical sensor 1210 may detect a change in color of the color-change member 1260 through one or more grooves (e.g., grooves corresponding to one or more grooves 133a and 133b) included in the first cover member 1250. In the example embodiment of FIG. 12, the optical sensor 1210 may detect a change in color of the color-change member 1260 through the at least one groove of the first cover member 1250 and the second cover member 1220 outside the second cover member 1220. Depending on example embodiments, the optical member 1210 may be provided between the first cover member 1250 and the second cover member 1220 and may be configured to detect the change in color of the color-change member 1260 through the at least one groove of the first cover member 1250.

Also, the second cover member 1220 may include the coupling member 1290 for coupling the optical sensor 1210 at a position corresponding to the at least one groove included in the first cover member 1260 such that the optical sensor 1210 may detect the change in color of the color-change member 1260. Here, the coupling member 1290 may include a transparent material such that the optical sensor 1210 may detect a change in color of the color-change member 1260.

Any sensor capable of detecting a change in color of the color-change member 1260, such as an optical diode or an optical camera, a sensor capable of recognizing RGB color difference, and the like, may be used for the optical sensor 1210 without limitation.

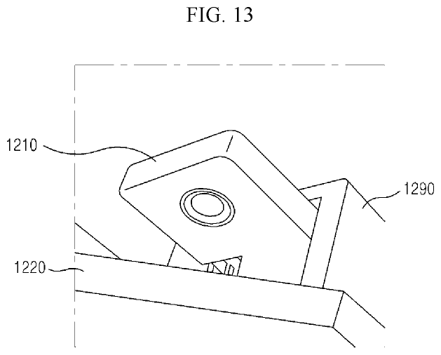

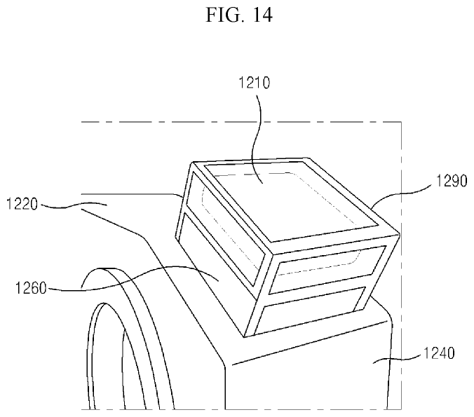

FIGS. 13 and 14 illustrate an example of an optical sensor and a coupling member according to another example embodiment of the present invention. FIG. 13 illustrates an example of the optical sensor 1210 just before being coupled to the coupling member 1290 formed in the second cover member 1220. Meanwhile, FIG. 14 illustrates an example of the optical sensor 1210 that is coupled to the coupling member 1290 formed in the second cover member 1220. In this case, the optical sensor 1210 may detect a change in the color-change member 1260 through the coupling member 1290 made of a transparent material, the second cover member 1220 made of a transparent material, and the window 1230 formed in the groove of the first cover member 1240.

Depending on example embodiments, the coupling member 1290 may include an open end in a direction in which the optical sensor 1210 and the color-change member 1260 face each other and may be implemented to not include a separate transparent material.

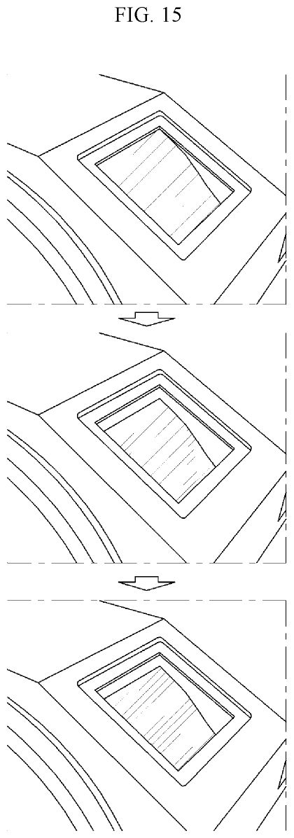

FIG. 15 illustrates an example of a change in color of a color-change member according to another example embodiment of the present invention. FIG. 15 illustrates a change in color of the color-change member 1260 identifiable from the outside through the window 1230 and the at least one groove included in the first cover member 1240. The optical sensor 1210 may detect the change (or alteration) in color of the color-change member 1260. In this case, the optical sensor 1210 may be implemented to output light and sound and/or may be implemented to transmit a warning signal to the external device through wireless communication.

The systems or the apparatuses described herein may be implemented using hardware components or combination of hardware components and software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, virtual equipment, or computer storage medium or device, to provide instructions or data to or to be interpreted by the processing device. The software also may be distributed over network coupled computer systems so that the software is stored and executed in a distributed fashion. The software and data may be stored by one or more computer readable storage mediums.

The methods according to the above-described example embodiments may be configured in a form of program instructions performed through various computer devices and recorded in computer-readable media. The media may also include, alone or in combination with the program instructions, data files, data structures, and the like. The media may continuously store a computer-executable program or may temporarily store the program for execution or download. Also, the media may be various recording methods or storage methods in which one or a plurality of hardware is combined and may be present on a network in a distributed manner without being limited to media directly connected to a computer system. Examples of the media include magnetic media such as hard disks, floppy disks, and magnetic tapes; optical media such as CD ROM discs and DVDs; magneto-optical media such as floptical disks; and hardware devices that are to store program instructions, such as read-only memory (ROM), random access memory (RAM), flash memory, and the like. Also, examples of other media may include recording media and storage media managed by an app store that distributes an application or a site, a server, etc., that supplies and distributes other various software. Examples of program instructions include both a machine code, such as produced by a compiler, and files containing a higher level code that may be executed by the computer using an interpreter.

### MODE

While the example embodiments are described with reference to specific example embodiments and drawings, it will be apparent to one of ordinary skill in the art that various changes and modifications in form and details may be made in these example embodiments from the description. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. A leak detection apparatus comprising:
a clamp member configured to attach to a connecting portion of a pipe;
a color-change member configured to surround at least a portion of the outer peripheral surface of the clamp member and of which color changes due to gas or chemicals leaking from the connecting portion of the pipe;
a first cover member configured to cover the clamp member and including at least one groove for visually verifying the color-change member from the outside; and
a second cover member configured to cover the first cover member and including a transparent material.

2. The leak detection apparatus of claim 1, further comprising:
an optical sensor configured to detect a change in the color of the color-change member through the at least one groove.

3. The leak detection apparatus of claim 2, wherein the second cover member further includes a coupling member configured to couple the optical sensor at a position corresponding to the at least one groove included in the first cover member such that the optical sensor detects the change in the color of the color-change member.

4. The leak detection apparatus of claim 3, wherein the coupling member includes a transparent material such that the optical sensor detects the change in the color of the color-change member.

5. The leak detection apparatus of claim 1, further comprising:
a drain configured to remove leaking gas or chemicals in a space between the clamp member and the first cover member.

6. The leak detection apparatus of claim 5, wherein the drain is configured to connect the space between the clamp member and the first cover member and an external space of the leak detection apparatus through grooves formed in the first cover member and the second cover member.

7. The leak detection apparatus of claim 5, further comprising:
a drain cover configured to insert into the second cover member through a groove formed in the second cover member while surrounding one side of the drain to prevent a leak of gas or chemicals through the drain.

8. The leak detection apparatus of claim 1, further comprising:
at least one gas detection sensor provided through the groove formed in the first cover member and configured to detect gas or chemicals leaking from the connecting portion of the pipe into the first cover member.

9. The leak detection apparatus of claim 1, wherein the clamp member includes:
an upper clamp member configured to cover top of the pipe; and
a lower clamp member configured to cover bottom of the pipe.

10. The leak detection apparatus of claim 9, wherein the first cover member includes:
an upper first cover member configured to surround the upper clamp member; and
a lower first cover member configured to surround the lower clamp member.

11. The leak detection apparatus of claim 8, wherein the second cover member includes:
an upper second cover member configured to surround the upper first cover member; and
a lower second cover member configured to surround the lower first cover member.

12. The leak detection apparatus of claim 11, further comprising:
a fluorine rubber member configured to cover a gap between the upper second cover member and the lower second cover member and a gap between the second cover member and the pipe.

13. The leak detection apparatus of claim 11, further comprising:
a locking device configured to couple the upper second cover member and the lower second cover member to prevent arbitrary separation between the upper second cover member and the lower second cover member.

14. The leak detection apparatus of claim 1, wherein the first cover member contains austenitic stainless steel as a material.

15. The leak detection apparatus of claim 1, wherein the second cover member contains polycarbonate or polyphenylene sulfide as a material.

16. The leak detection apparatus of claim 1, wherein the color-change member includes:
an upper color-change member configured to surround at least a portion of the upper outer peripheral surface of the clamp member along the upper outer peripheral curved surface of the clamp member; and
a lower color-change member configured to surround at least a portion of the lower outer peripheral surface of the clamp member along the lower outer peripheral curved surface of the clamp member.

17. The leak detection apparatus of claim 1, further comprising:
at least one gas detection sensor provided through the groove formed in the first cover member and configured to detect gas leaking from the connecting portion of the pipe into the first cover member.
